(19) United States
(12) Patent Application Publication
(10) Pub. No.: US 2024/0164594 A1
(43) Pub. Date: May 23, 2024

(54) Body Scrubbing Device

(71) Applicant: Jazmin Skidmore, Stafford, VA (US)

(72) Inventor: Jazmin Skidmore, Stafford, VA (US)

(21) Appl. No.: 18/507,170

(22) Filed: Nov. 13, 2023

Related U.S. Application Data
(60) Provisional application No. 63/427,210, filed on Nov. 22, 2022.

(51) Int. Cl. A47K 7/02; A61H 7/00

(52) U.S. Cl. CPC A47K 7/024; A61H 7/004

(57) ABSTRACT

The present invention relates to a body scrubbing device that can be secured around a chair or a wall to allow a user to wash and/or massage their back or other body parts during a shower. The device is primarily comprised of a body with at least one massage element and/or at least one scrubbing element, and at least one fastener. The device can be attached to a structure such as, but not limited to, a chair, a wall, or a floor via the fastener. Once secured, a user can rub a body part (preferably their back) against the scrubbing element and/or massage element. This allows a user to clean and/or massage said body part.

### CROSS-REFERENCE TO RELATED APPLICATION

The present application claims priority to, and the benefit of, U.S. Provisional Application No. 63/427,210, which was filed on Nov. 22, 2022, and is incorporated herein by reference in its entirety.

### FIELD OF THE INVENTION

The present invention relates generally to the field of body washing devices. More specifically, the present invention relates to a body scrubbing device that can be secured around a chair or a wall to allow a user to wash and/or massage their back or other body parts during a shower. Accordingly, the present disclosure makes specific reference thereto. Nonetheless, it is to be appreciated that aspects of the present invention are also equally applicable to other like applications, devices, and methods of manufacture.

### BACKGROUND

An individual may have trouble washing or scrubbing their back independently. As a result, an individual may have to contort their body in awkward positions to reach the back with a standard washcloth, loofah, etc. In addition, individuals with physical limitations may be unable to scrub and wash their own back, as well as other hard-to-reach areas of the body.

Therefore, there exists a long-felt need in the art for an improved body washing device. More specifically, there exists a long-felt need in the art for a body scrubbing device. There also exists a long-felt need in the art for a body scrubbing device that allows a user to scrub hard-to-reach areas of their body independently. In addition, there exists a long-felt need in the art for a body scrubbing device that allows a user to scrub hard-to-reach areas of their body independently, wherein the device can be attached to a structure such as, but not limited to, a chair, a wall, or a floor.

The subject matter disclosed and claimed herein, in one embodiment thereof, comprises a body scrubbing device. The device is primarily comprised of a body with at least one massage element and/or at least one scrubbing element, and at least one fastener. The device can be attached to a structure such as, but not limited to, a chair, a wall, or a floor via the fastener. Once secured, a user can rub a body part (preferably their back) against the scrubbing element and/or massage element. This allows a user to clean and/or massage said body part. In the preferred element, the scrubbing element is comprised of a loofah material.

In this manner, the body scrubbing device of the present invention accomplishes all the foregoing objectives and provides a device that allows a user to scrub hard to reach areas of their body independently. In addition, there exists a long-felt need in the art for a body scrubbing device that allows a user to scrub hard-to-reach areas of their body independently, wherein the device can be attached to a structure such as, but not limited to, a chair, a wall, or a floor.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a body scrubbing device primarily comprised of a body with at least one massage element and/or at least one scrubbing element, and at least one fastener. The device is intended to be used within/during a shower or bathing. The device allows a user to clean and/or massage their back or other body parts by rubbing against the device during use. The body of the device is preferably made from a waterproof material? of any shape known in the art.

In one embodiment, the device can be used with a shower or bathing chair, wherein the rear surface of the body is comprised of at least one fastener that allows the body to attach to and/or around the chair. As a result, the body can be secured to the chair such that an individual can sit in the chair and scrub their body (preferably their back) against the front surface of the body.

The front surface of the body may be comprised of at least one massage element comprised of at least one rounded, rubber protrusion. However, the front surface may have any type of massaging element known in the art. In this manner, a user can rub their back or another body part against the front surface while bathing.

In a different embodiment, the front surface is comprised of a scrubbing element that allows a user to clean their body (preferably their back) by rubbing their body against the element. The scrubbing element may be comprised of any natural or synthetic loofah material known in the art. In other embodiments, the scrubbing element may be any other type of body scrubbing structure known in the art such as, but not limited to, bristles.

In another embodiment, the device may be attached to a shower wall or a shower floor, wherein the rear surface of the body may be comprised of at least one fastener that allows the body to attach to the wall or floor. As a result, the body can be secured to the wall or floor such that an individual can scrub their body (preferably their back or foot) against the front surface of the body.

It should be noted that in different embodiments, the device may feature only a massage element, only a scrubbing element, both elements on different surfaces of the body, or both elements on one surface of the body.

The present invention is also comprised of a first method of use for a first embodiment of the device designed to be used with a chair. First, a device is provided having either a continuous loop body with at least one massage element and at least one scrubbing element, or a device having a body with a front surface comprised of a massage element and/or a scrubbing element and a rear surface comprised of at least one fastener. Then, the body is secured to a chair by placing the body over the backrest of the chair or securing the fastener to the chair. Then, a user can rub their body across the front surface to massage and/or scrub their body while bathing.

The present invention is also comprised of a second method of use for a second embodiment of the device designed to be used while attached to a wall or a floor. First, a device is provided having a body with a front surface comprised of a massage element and/or a scrubbing element and a rear surface comprised of at least one fastener. Then, the body is secured to a wall or a floor by securing the fastener to the wall or floor. Then, a user can rub their body across the front surface to massage and/or scrub their body while bathing.

Accordingly, the body scrubbing device of the present invention is particularly advantageous as it provides a body scrubbing device that allows a user to scrub hard to reach areas of their body independently. In addition, the device allows a user to scrub hard to reach areas of their body independently, wherein the device can be attached to a structure such as, but not limited to, a chair, a wall, or a floor. In this manner, the body scrubbing device overcomes the limitations of existing methods and devices used to wash hard-to-reach areas of the body known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a body scrubbing device of the present invention while attached to a chair in accordance with the disclosed architecture;

FIG. 2 illustrates a rear perspective view of one potential embodiment of a body scrubbing device of the present invention while attached to a chair in accordance with the disclosed architecture;

FIG. 3 illustrates a perspective view of one potential embodiment of a body scrubbing device of the present invention while attached to a chair in accordance with the disclosed architecture;

FIG. 4 illustrates a side view of two potential embodiments of a body scrubbing device of the present invention while attached to a wall and a floor in accordance with the disclosed architecture;

FIG. 5 illustrates a flowchart of a method of using one potential embodiment of a body scrubbing device of the present invention in accordance with the disclosed architecture; and

FIG. 6 illustrates a flowchart of a method of using one potential embodiment of a body scrubbing device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved body washing device. More specifically, there exists a long-felt need in the art for a body scrubbing device. There also exists a long-felt need in the art for a body scrubbing device that allows a user to scrub hard to reach areas of their body independently. In addition, there exists a long-felt need in the art for a body scrubbing device that allows a user to scrub hard-to-reach areas of their body independently, wherein the device can be attached to a structure such as, but not limited to, a chair, a wall, or a floor.

The present invention, in one exemplary embodiment, is comprised of a body scrubbing device primarily comprised of a body with at least one massage element and/or at least one scrubbing element, and at least one fastener. The device is intended to be used within/during a shower or bathing to allow a user to clean and/or massage their back or other body parts by rubbing against the device during use. The body of the device is preferably made from a waterproof material? of any shape known in the art.

In one embodiment, the device can be used with a shower or bathing chair. In this embodiment, the rear surface of the body is comprised of at least one fastener. The fastener allows the body to attach to and/or around the chair. As a result, the body can be secured to the chair such that an individual can sit in the chair and scrub their body (preferably their back) against the front surface of the body.

The front surface of the body may be comprised of at least one massage element comprised of at least one rounded, rubber protrusion. However, the front surface may have any type of massaging element known in the art. In this manner, a user can rub their back or another body part against the front surface while bathing.

In a different embodiment, the front surface is comprised of a scrubbing element. The scrubbing element allows a user to clean their body (preferably their back) by rubbing their body against the element. The scrubbing element may be comprised of any natural or synthetic loofah material known in the art. In other embodiments, the scrubbing element may be any other type of body scrubbing structure known in the art such as, but not limited to, bristles.

In another embodiment, the device may be attached to a shower wall or a shower floor, wherein the rear surface of the body may be comprised of at least one fastener that allows the body to attach to the wall or floor. As a result, the body can be secured to the wall or floor such that an individual can scrub their body (preferably their back or foot) against the front surface of the body.

In different embodiments, the device may feature only a massage element, only a scrubbing element, both elements on different surfaces of the body, or both elements on one surface of the body.

The present invention is also comprised of a first method of use for a first embodiment of the device designed to be used with a chair. First, a device is provided having either a continuous loop body with at least one massage element and at least one scrubbing element, or a device having a body with a front surface comprised of a massage element and/or a scrubbing element and a rear surface comprised of at least one fastener. Then, the body is secured to a chair by placing the body over the backrest of the chair or securing the fastener to the chair. Then, a user can rub their body across the front surface to massage and/or scrub their body while bathing.

The present invention is also comprised of a second method of use for a second embodiment of the device designed to be used while attached to a wall or a floor. First, a device is provided having a body with a front surface comprised of a massage element and/or a scrubbing element and a rear surface comprised of at least one fastener. Then, the body is secured to a wall or a floor by securing the fastener to the wall or floor. Then, a user can rub their body across the front surface to massage and/or scrub their body while bathing.

Accordingly, the body scrubbing device of the present invention is particularly advantageous as it provides a body scrubbing device that allows a user to scrub hard-to-reach areas of their body independently. In addition, the device allows a user to scrub hard to reach areas of their body independently, wherein the device can be attached to a structure such as, but not limited to, a chair, a wall, or a floor. In this manner, the body scrubbing device overcomes the limitations of existing methods and devices used to wash hard-to-reach areas of the body known in the art.

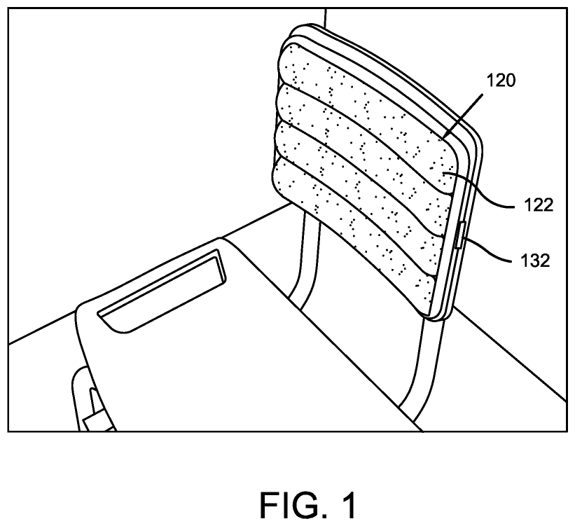

Referring initially to the drawings, FIG. 1 illustrates a perspective view of one potential embodiment of a body scrubbing device 100 of the present invention while attached to a chair 10 in accordance with the disclosed architecture. The device 100 is primarily comprised of a body 110 with at least one massage element 122 and/or at least one scrubbing element 124, and at least one fastener 132. The device 100 is intended to be used within/during a shower or bathing. The device 100 allows a user to clean and/or massage their back or other body parts by rubbing against the device 100 during use.

The body 110 of the device 100 is preferably made from a waterproof and mildew-resistant material. The body 110 may be made from a rigid material or a foam-like material for comfort. The body 110 may have any shape known in the art such as, but not limited to, square, circular, triangular, etc. The shape of the body 110 may also resemble any object, item, character, animal, symbol, etc.

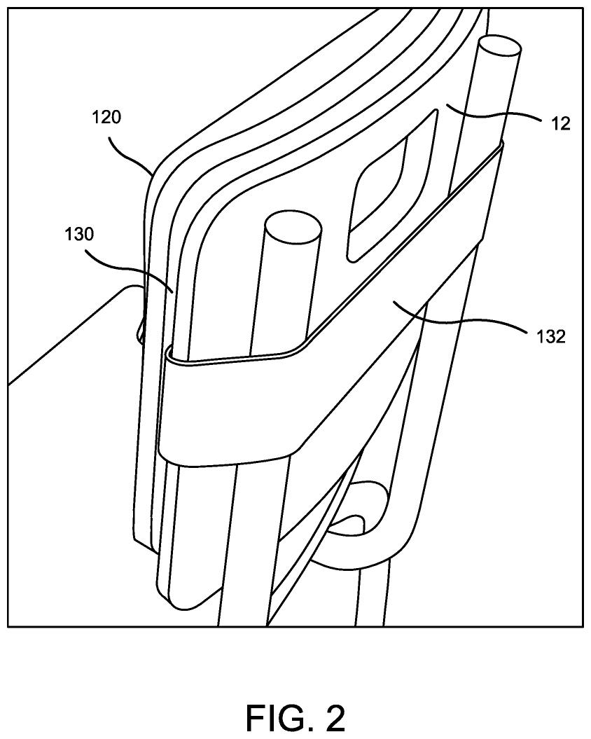

In one embodiment, the device 100 can be used with a shower or bathing chair 10. In this embodiment, the rear surface 130 of the body 110 may be comprised of at least one fastener 132 that allows the body 110 to attach to and/or around the chair 10, as seen in FIG. 2. The fastener 132 may be any type known in the art such as, but not limited to, a fixed length strap, an adjustable strap, a suction cup, a tie, etc. As a result, the body 110 can be secured to the chair 10 such that an individual can sit in the chair 10 and scrub their body (preferably their back) against the front surface 120 of the body 110.

The front surface 120 of the body 110 may be comprised of at least one massage element 122. The massage element 122 is preferably comprised of at least one rounded, rubber protrusion. However, the front surface 120 may have any type of massaging element known in the art. In this manner, a user can rub their back or another body part against the front surface 120 while bathing.

In a different embodiment, the front surface 120 is comprised of a scrubbing element 124. The scrubbing element 124 allows a user to clean their body (preferably their back) by rubbing their body against the element 124. The scrubbing element 124 may be comprised of any natural or synthetic loofah material known in the art. In other embodiments, the scrubbing element 124 may be any other type of body scrubbing structure known in the art such as, but not limited to, bristles.

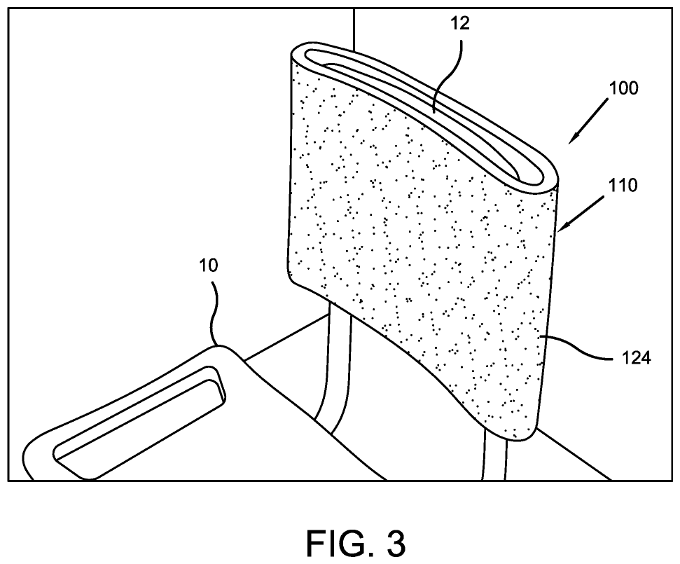

One embodiment of the device 100 intended to be used with a chair 10 is comprised of a continuous, looped body 110 that can be placed over the backrest 12 of a chair 10, as seen in FIG. 3. This embodiment is comprised of no fastener 132. Instead, the front surface 120 is comprised of the massage element 122 and the rear surface 130 is comprised of the scrubbing element 124. This embodiment allows a user to rotate the device 100 around the backrest 12 as desired to massage or scrub their body.

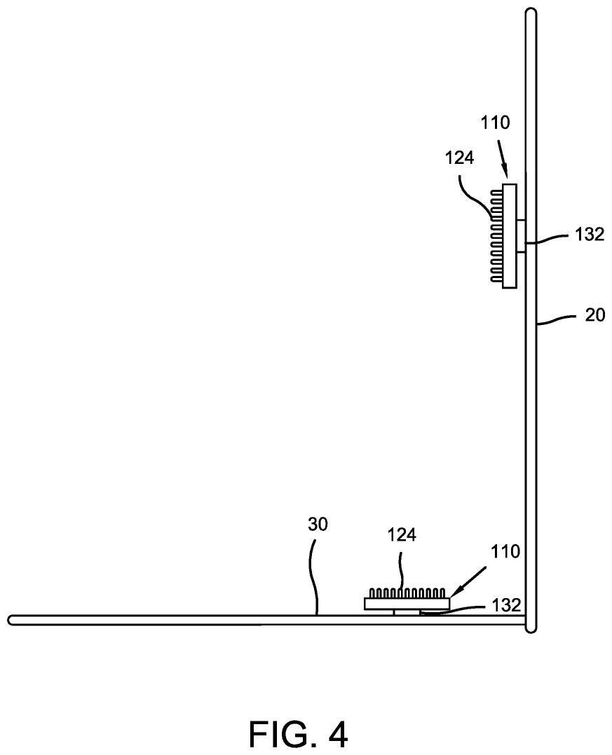

In another embodiment, the device 100 may be attached to a shower wall 20 or a shower floor 30, as seen in FIG. 4. In this embodiment, the rear surface 130 of the body 110 may be comprised of at least one fastener 132 that allows the body 110 to attach to the wall 20 or floor 30. The fastener 132 may be any type known in the art such as, but not limited to, a suction cup, an adhesive, a magnet, etc. As a result, the body 110 can be secured to the wall 20 or floor 30 such that an individual can scrub their body (preferably their back or foot) against the front surface 120 of the body 110.

The front surface 120 of the body 110 may be comprised of at least one massage element 122. The massage element 122 is preferably comprised of at least one rounded, rubber protrusion. However, the front surface 120 may have any type of massaging element known in the art. In this manner, a user can rub their back or another body part against the front surface 120 while bathing.

In a different embodiment, the front surface 120 is comprised of a scrubbing element 124. The scrubbing element 124 allows a user to clean their body (preferably their back or foot) by rubbing their body against the element 124. The scrubbing element 124 may be comprised of any natural or synthetic loofah material known in the art. In other embodiments, the scrubbing element 124 may be any other type of body scrubbing structure known in the art such as, but not limited to, bristles.

It should be noted that in different embodiments, the device 100 may feature only a massage element 122, only a scrubbing element 124, both elements 122, 124 on different surfaces 120, 130 of the body 110, or both elements 122, 124 on one surface 120 (or 130) of the body 110.

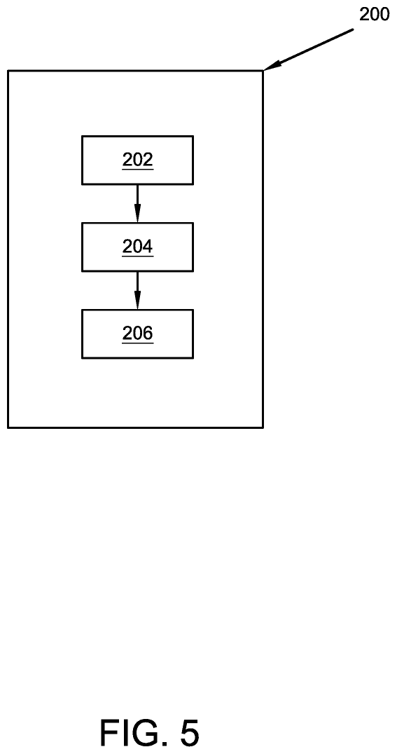

The present invention is also comprised of a first method of use 200 for a first embodiment of the device 100 designed to be used with a chair 10, as seen in FIG. 5. First, a device 100 is provided having either a continuous loop body 110 with at least one massage element 122 and at least one scrubbing element 124, or a device 100 having a body 110 with a front surface 120 comprised of a massage element 122 and/or a scrubbing element 124 and a rear surface 130 comprised of at least one fastener 132 [Step 202]. Then, the body 110 is secured to a chair 10 by placing the body 110 over the backrest 12 of the chair 10 or securing the fastener 132 to the chair 10 [Step 204]. Then, a user can rub their body across the front surface 120 to massage and/or scrub their body while bathing [Step 206].

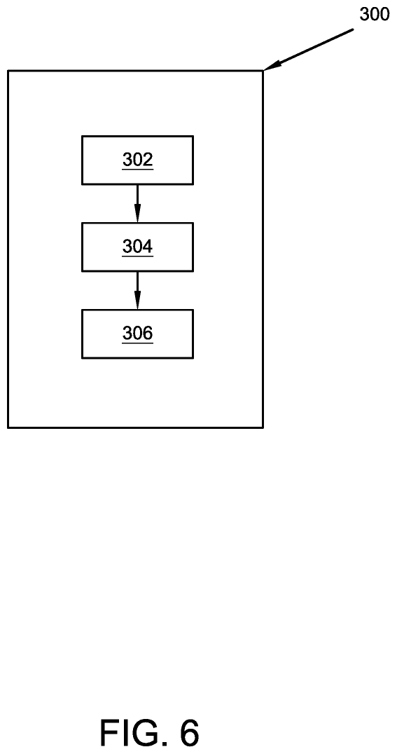

The present invention is also comprised of a second method of use 300 for a second embodiment of the device 100 designed to be used while attached to a wall 20 or a floor 30, as seen in FIG. 6. First, a device 100 is provided having a body 110 with a front surface 120 comprised of a massage element 122 and/or a scrubbing element 124 and a rear surface 130 comprised of at least one fastener 132 [Step 302]. Then, the body 110 is secured to a wall 20 or a floor 30 by securing the fastener 132 to the wall 20 or floor 30 [Step 304]. Then, a user can rub their body across the front surface 120 to massage and/or scrub their body while bathing [Step 306].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “body scrubbing device” and “device” are interchangeable and refer to the body scrubbing device 100 of the present invention.

Notwithstanding the foregoing, the body scrubbing device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the body scrubbing device 100 as shown in the FIGS. are for illustrative purposes only, and that many other sizes and shapes of the body scrubbing device 100 are well within the scope of the present disclosure. Although the dimensions of the body scrubbing device 100 are important design parameters for user convenience, the body scrubbing device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A body scrubbing device comprising:
a looped body;
a massage element; and
a scrubbing element.

2. The body scrubbing device of claim 1, wherein the looped body is comprised of waterproof material.

3. The body scrubbing device of claim 1, wherein the massage element is comprised of a protrusion.

4. The body scrubbing device of claim 1, wherein the scrubbing element is comprised of a loofah.

5. A body scrubbing device comprising:
a body comprised of a front surface and a rear surface;
an element positioned on the front surface; and
a fastener positioned on the rear surface.

6. The body scrubbing device of claim 5, wherein the element is comprised of a massage element.

7. The body scrubbing device of claim 6, wherein the massage element is comprised of a protrusion.

8. The body scrubbing device of claim 5, wherein the element is comprised of a scrubbing element.

9. The body scrubbing device of claim 8, wherein the scrubbing element is comprised of a loofah.

10. The body scrubbing device of claim 9, wherein the loofah is comprised of a natural loofah.

11. The body scrubbing device of claim 8, wherein the scrubbing element is comprised of a bristle.

12. The body scrubbing device of claim 5, wherein the fastener is comprised of a suction cup.

13. The body scrubbing device of claim 5, wherein the fastener is comprised of an adhesive.

14. A method of cleaning oneself, the method comprising the steps of:
providing a body scrubbing device comprised of an element;
securing the body scrubbing device to a structure; and
rubbing the element on a body part.

15. The method of claim 14, wherein the element is comprised of a massaging element.

16. The method of claim 15, wherein the massaging element is comprised of a protrusion.

17. The method of claim 14, wherein the element is comprised of a scrubbing element.

18. The method of claim 17, wherein the scrubbing element is comprised of a loofah.

19. The method of claim 14, wherein the body scrubbing device is comprised of a fastener.

20. The method of claim 14, wherein the fastener secures the body to the structure.
